(19) United States
(12) Patent Application Publication
(10) Pub. No.: US 2025/0171922 A1
(43) Pub. Date: May 29, 2025

(54) ASU Electrolyser System

(71) Applicant: Ceres Intellectual Property Company Limited, Horsham, West Sussex (GB)

(72) Inventor: Hacib Ben BEM AISSA, Horsham, West Sussex (GB)

(21) Appl. No.: 18/841,041

(22) PCT Filed: Feb. 20, 2023
(86) PCT No.: PCT/GB2023/050374

§ 371 Date: Aug. 23, 2024

(30) Foreign Application Priority Data
Feb. 24, 2022 (GB) 2202557.1

(51) Int. Cl. C25B 15/08; B01D 53/053; C25B 1/042; C25B 13/05; C25B 15/027

(52) U.S. Cl. CPC C25B 15/081; B01D 53/053; C25B 1/042; C25B 13/05; C25B 15/027; B01D 2256/10

(57) ABSTRACT

An air separation system includes an air separation unit and at least one solid oxide electrolyser cell, the air separation unit including a source gas infeed, the at least one solid oxide electrolyser cell including an anode, a cathode and an electrolyte, a steam input and an oxygen rich gas output, where the oxygen rich gas output connects to the source gas infeed of the air separation unit.

### CROSS REFERENCE TO RELATED APPLICATIONS

The present application is a § 371 national stage of international application no. PCT/GB2023/050374, filed Feb. 20, 2023, which claims priority to United Kingdom application no. 2202557.1, filed Feb. 24, 2022, the entire contents of both of which are hereby incorporated by reference herein.

### FIELD

The present invention relates to an electrolyser system integrated into an industrial air separation process, for example using air separation units, or cryogenic air separation units, commonly known as ASUs, or vacuum pressure swing adsorption (VPSA), to improve the efficiencies thereof.

### BACKGROUND

The materials described in this section are not admitted to be prior art by inclusion in this section.

An air separation plant separates atmospheric air into its primary components, typically nitrogen and oxygen, and sometimes also argon and other rare inert gases.

The most common method for air separation is fractional distillation, for example using an air separation unit (ASU) (a cryogenic distillation process). ASU systems, also known as cryogenic air separation units, are built to separate nitrogen or oxygen, and often to co-produce argon, from air.

Other methods of air separation are also used commercially to separate the components of air, such as membrane and pressure swing adsorption (PSA) systems. Although commonly targeting a single gas component (e.g. oxygen), they can also separate multiple components from the air (e.g. argon and oxygen and potentially other components too).

Pure gases can be separated from air in an ASU by first cooling it (cryogenic cooling) until it at least partially liquefies, and then selectively distilling the components at their various boiling temperatures using controlled changes in the temperature and pressure of the liquid, for example by allowing the air temperature to rise, or the pressure to drop. The process can produce high purity gases. A schematic illustration of an example of an ASU is shown in FIG. 1, as appended hereto.

This cryogenic air separation process requires heat exchangers, air compressors and separation columns, and the energy for refrigeration (cooling). The process is energy-intensive due to the requirement to refrigerate the air to low temperatures, and to pressurise it to high temperatures.

Pressure swing adsorption (PSA) is instead a technique for separating gas species from a mixture of gases (typically air) under pressure. The species' molecular characteristics and affinity for an adsorbent material allow this process to be controlled. Often PSA systems operate at near-ambient temperature. Adsorbent materials such as zeolites, (aka molecular sieves) and activated carbon are used as the trapping material. They preferentially adsorb the target gas species at high pressure. The process drops the pressure to desorb the adsorbed gas. Variants of these PSA systems include double stage PSA, rapid PSA, vapour pressure swing adsorption, vacuum swing adsorption (VSA) and vacuum pressure swing adsorption (VPSA) systems.

Vacuum swing adsorption (VSA) systems segregate certain gases from a gaseous mixture at near ambient pressure. The process then swings to a vacuum to release the adsorbent material. The VSA process typically draws the gas through the separation process with a vacuum. For oxygen and nitrogen VSA systems, the vacuum is typically generated by a blower.

Hybrid “vacuum pressure swing adsorption” (VPSA) systems apply pressurized gas to the separation process and apply a vacuum to the purge gas. This can provide a more efficient system and is becoming more widely adopted.

A schematic illustration of a typical PSA system is shown in FIG. 5, as appended hereto.

For the purpose of this application the various forms and variants of PSA system will be collectively referred to as pressure swing adsorption systems (or PSA systems).

Adsorbents for PSA systems are usually chosen for their porous characteristics as that provides a large surface area into or onto which the species can be adsorbed. Typical adsorbents are zeolite, activated carbon, silica gel, alumina and synthetic resins. The gas adsorbed on these large surface areas may only consist of a thin layer—perhaps only one or at most a few molecules thick, but the large surface areas—perhaps several hundred square meters per gram, enable the adsorption of a relatively large portion of the adsorbent's weight in gas.

In addition to their affinity for different gases, zeolites and some types of activated carbon may utilize their molecular sieve characteristics to exclude some gas molecules from their structure based on the size and shape of the molecules, thereby restricting the ability of the larger molecules to be adsorbed.

A common problem with ASU systems and PSA systems is that the output of oxygen obtainable from the volume of source gas inputted air is limited by the volumetric makeup of that air. Ambient air is typically approximately 78% nitrogen, 21% oxygen and 1% argon and other elements, whereby no matter how much the rate of processing of the air is improved, the process is limited to producing at most 21% of that volume in oxygen. As oxygen is often the main target output from the air separating system, especially given the increasing demand for, and thus increasing value of, oxygen, especially in the current Coved pandemic, it would be desirable to increase that oxygen output.

Another problem with ASUs is that they are highly energy inefficient. An ASU needs to operate at cryogenic temperatures, and the energy used to cool the gas to be separated can be lost when the vented nitrogen is allowed to reheat in storage tanks, or elsewhere downstream of the ASU.

### SUMMARY

According to a first aspect of the present invention there is provided an air separation system comprising an air separation unit (ASU) and at least one solid oxide electrolyser cell (SOEC or SOEL cell);
the air separation unit comprising a source gas infeed;
the at least one solid oxide electrolyser cell comprising an anode, a cathode and an electrolyte, a steam input and an oxygen rich gas output, wherein the oxygen rich gas output connects to the source gas infeed of the air separation unit. With this arrangement, the source gas (for example ambient air) can be enriched by oxygen rich gas exiting the oxygen rich gas output during operation of the at least one solid oxide electrolyser cell, or the oxygen rich gas can be the source gas.

In addition to the problems with prior art air separation units, the present inventors have also noted energy inefficiencies in solid oxide electrolysers and solid oxide electrolyser cells (SOECs and SOELs) in that the input steam and air need to be heated before entry to allow the high operating temperature of the SOEC/SOEL to be maintained. Likewise the gas outputs from the SOEC/SOEL are hot, and thus that heat energy can be wasted if those outputs are allowed to cool in storage tanks or elsewhere downstream of the SOECs.

The present inventors have realised that combining the ASU and SOEC/SOEL technologies can smooth out some of the energy inefficiencies, and further that there can be additional benefits to improve the quality of the output hydrogen and the operational efficiency of the air separation systems.

In some embodiments the oxygen rich gas will have an oxygen content greater than that of ambient air, i.e. greater than 21%. Preferably it will be 23 to 24% or higher.

The air separation unit usually has a nitrogen output. A nitrogen stream will exit the nitrogen output during use of the air separation unit.

In some embodiments the nitrogen output is connected to the at least one solid oxide electrolyser cell to feed the nitrogen stream from the air separation unit to the at least one solid oxide electrolyser cell during use of the air separation unit. The input gases to the at least one solid oxide electrolyser cell are therefore steam and nitrogen.

The at least one solid oxide electrolyser cell usually has a hydrogen output. A hydrogen stream will exit the hydrogen output during use of the at least one solid oxide electrolyser cell.

In use the hydrogen stream exiting the at least one solid oxide electrolyser cell will be hotter than the nitrogen stream exiting the air separation unit.

In some embodiments the hydrogen stream and the nitrogen stream pass through a heat exchanger to exchange heat between the hydrogen stream and the nitrogen stream (e.g. to cool the hydrogen stream and to heat the nitrogen stream). Cooling the hydrogen stream can help to dry the hydrogen as it will typically be a wet feed from the at least one solid oxide electrolyser cell.

If the nitrogen stream is connected to the at least one solid oxide electrolyser cell, heating the nitrogen stream will prepare it for use in the at least one solid oxide electrolyser cell.

In some embodiments the oxygen rich gas output is thermally connected across a heat exchanger to a gas infeed for the at least one solid oxide electrolyser cell, such as an air feed or a nitrogen stream feed, or even the steam. In other words, the oxygen rich gas output and a gas infeed for the at least one solid oxide electrolyser cell are in fluid flow communication with a heat exchanger for exchanging heat between the oxygen rich gas and the gas infeed for the at least one solid oxide electrolyser cell. This allows the oxygen rich gas (oxygen enriched nitrogen) exiting the oxygen rich gas output during operation of the at least one solid oxide electrolyser cell, which will be hot from the at least one solid oxide electrolyser cell, to be cooled and the gas infeed to be heated, i.e. for the heat of one to be exchanged with the other.

In some embodiments, the hydrogen output is connected to the air separation unit.

In some embodiments the air separation unit comprises at least one filter system for filtering entrained solids out of the compressed source gas, such as dust and pollen. The at least one filter system may be a molecular sieve, as known in the art. It may be sized to allow nitrogen and oxygen particles to pass through but to entrap most entrained impurities in the gas flow.

In some embodiments the hydrogen output is connected to at least one filter system to filter entrained solids from the hydrogen stream output by the at least one solid oxide electrolyser cell during operation of the at least one solid oxide electrolyser cell. Preferably it is at least one of the filter systems of the air separation unit.

In some embodiments the air separation unit further comprises an air compressor for compressing a source gas after it has been fed into the source gas infeed.

In some embodiments the air separation unit comprises at least one cooler for cooling the compressed source gas to produce a cooled air stream.

If the hydrogen stream is first cooled by the nitrogen stream when passing through the heat exchanger, the hydrogen stream can be connected to the air separation unit at a temperature close or closer to the source gas temperature, or more preferably close or closer to the temperature of the cooled air stream.

In some embodiments the cooled air stream is fed through the at least one filter system.

In some embodiments the hydrogen output is connected to the cooled air stream of the air separation unit, either directly or thermally via a heat exchanger, the cooled air stream being able to condense or freeze steam particles entrained in the hydrogen stream so that they can be filtered out of the hydrogen stream by a filter (as water or ice can be entrapped by an appropriate filter), along with other filterable impurities. In some embodiments the filter is the at least one filter system of the air separation unit.

In some embodiments the air separation unit further comprises at least one heat exchanger.

In some embodiments the air separation unit further comprises a cryogenic cooler.

In some embodiments the air separation unit further comprises at least two pressure columns, one at a relatively higher pressure than the other.

According to a second aspect of the present invention there is provided an air separation system comprising an air separation unit (ASU) and at least one solid oxide electrolyser cell (SOEC or SOEL cell);
the air separation unit comprising a source gas infeed and a nitrogen output;
the at least one solid oxide electrolyser cell comprising an anode, a cathode and an electrolyte, a steam input and a hydrogen output;
wherein the nitrogen output thermally connects to the hydrogen output across a heat exchanger so that a nitrogen stream from the nitrogen output can cool a hydrogen stream from the hydrogen output. In other words, the nitrogen output and the hydrogen output are in fluid flow communication with a heat exchanger for exchanging heat between a nitrogen stream from the nitrogen output and a hydrogen stream from the hydrogen output.

According to a third aspect of the present invention there is provided an air separation system comprising an air separation unit (ASU) and at least one solid oxide electrolyser cell (SOEC or SOEL cell);
the air separation unit comprising a source gas infeed and a nitrogen output;
the at least one solid oxide electrolyser cell comprising an anode, a cathode and an electrolyte, a steam input and an oxygen rich gas output;
wherein the nitrogen output thermally connects to the oxygen rich gas output across a heat exchanger so that a nitrogen stream from the nitrogen output can cool a oxygen rich gas stream from the oxygen rich gas output. In other words, the nitrogen output and the oxygen rich gas output are in fluid flow communication with a heat exchanger for exchanging heat between a nitrogen stream from the nitrogen output and an oxygen rich gas steam from the oxygen rich gas output.

According to a fourth aspect of the present invention there is provided an air separation system comprising an air separation unit (ASU) and at least one solid oxide electrolyser cell (SOEC or SOEL cell);
the air separation unit comprising a source gas infeed and a nitrogen output;
the at least one solid oxide electrolyser cell comprising an anode, a cathode and an electrolyte, a steam input, a nitrogen rich gas input, an oxygen rich gas output and a hydrogen output;
wherein the nitrogen output connects to the nitrogen rich gas input, and a nitrogen stream from the nitrogen output to the nitrogen rich gas input thermally connects to either or both of a) a oxygen rich gas stream from the oxygen rich gas output and b) a hydrogen stream from the hydrogen output, in each case across one or more heat exchanger, so that the nitrogen stream can be heated thereby before entering the nitrogen rich gas input of the at least one solid oxide electrolyser cell. In other words, before connecting to the nitrogen rich gas input of the at least one solid oxide electrolyser cell, the nitrogen output and at least one of a) an oxygen rich gas stream from the oxygen rich gas output and b) a hydrogen stream from the hydrogen output are in fluid flow communication with at least one heat exchanger for exchanging heat between a nitrogen stream from the nitrogen output and the at least one of a) an oxygen rich gas stream from the oxygen rich gas output and b) a hydrogen stream from the hydrogen output.

By using the nitrogen stream from the ASU, less ambient air is required to be drawn into the SOEC whereby there will be fewer additional components to that gas infeed—i.e. a more pure nitrogen supply, and less carbon dioxide and other contaminants. The system can even be a closed loop system if the oxygen rich gas stream is connected to the source gas infeed of the ASU, in accordance with the first aspect of the present invention.

The first aspect can be combined with any one or more of the second, the third or the fourth aspects. Likewise the second aspect can be combined with any one or more of the third or fourth aspects. Likewise the third aspect can be combined with the fourth aspect. Indeed any two or more of these four aspects of the present invention can be combined together.

In each case, the air separation unit may comprise additionally an air compressor for compressing a source gas after it has been fed into the source gas infeed, at least one additional heat exchanger, a cryogenic cooler and at least two pressure columns, one at a relatively higher pressure than the other.

In accordance with a fifth aspect of the present invention there is also provided a method of operating an air separation system, the air separation system comprising an air separation unit (ASU) and a solid oxide electrolyser cell (SOEC or SOEL cell);
the air separation unit comprising a source gas infeed;
the at least one solid oxide electrolyser cell comprising an anode, a cathode and an electrolyte, a steam input and an oxygen rich gas output, wherein the oxygen rich gas output is connected to the source gas infeed of the air separation unit.

In some embodiments the source gas is oxygen enriched compared to ambient air by oxygen rich gas from the oxygen rich gas output. As a result, a percentage of oxygen in a to-be-separated gas that passes through the air separation unit is increased versus a percentage of oxygen in ambient air.

In some embodiments a nitrogen output from the air separation unit is connected to the at least one solid oxide electrolyser cell to feed a nitrogen stream from the nitrogen output to the at least one solid oxide electrolyser cell. Preferably the nitrogen stream replaces an air feed into the at least one solid oxide electrolyser cell, whereby the input gases to the at least one solid oxide electrolyser cell are steam and nitrogen. An air feed may be connected during system start up, or if the nitrogen stream is otherwise not available. Alternatively, by using a buffer tank for storing nitrogen, the buffer tank may be used for start-up.

In some embodiments, the source gas consists of just the oxygen rich gas from the at least one solid oxide electrolyser cell, rather than supplementing an externally sourced source gas, whereby the air separation unit is just fed the oxygen rich gas from the at least one solid oxide electrolyser cell. If additionally the at least one solid oxide electrolyser cell is fed the nitrogen stream from the air separation unit, rather than ambient air, a closed loop can be created, with steam being added to the at least one solid oxide electrolyser cell as a source of hydrogen and oxygen for the system. With this arrangement, feed impurities (as would be introduced if using ambient air rather than the nitrogen stream) can be greatly reduced or eradicated. Also, argon, as usually present in small percentages in air, would no longer need to be separated from the to-be-separated gas flowing through the system as the circulating gas would no longer contain argon (or any argon from the initial start-up gas, if not from a nitrogen buffer tank, could be initially removed from the thereafter closed loop of nitrogen gas, and then that part of the separation process could be discontinued).

In some embodiments a hydrogen stream exiting the at least one solid oxide electrolyser cell and a nitrogen stream exiting a nitrogen output of the air separation unit both pass through a heat exchanger to cool the hydrogen stream and to heat the nitrogen stream.

In some embodiments the oxygen rich gas output thermally connects across a heat exchanger to a gas infeed for the at least one solid oxide electrolyser cell, such as an air feed or a nitrogen stream feed, or even a steam stream for the steam input, so that the oxygen rich gas exiting the oxygen rich gas output, which is hot from the operation of the at least one solid oxide electrolyser cell, is cooled prior to downstream distribution and so that the gas stream for the gas infeed (for example the air feed or the nitrogen stream feed or the steam stream) is heated prior to entry into the at least one solid oxide electrolyser cell. In other words, the oxygen rich gas output and at least one gas infeed for the at least one solid oxide electrolyser cell are in fluid flow communication with at least one heat exchanger for exchanging heat between an oxygen rich gas stream from the oxygen rich gas output and the at least one gas infeed for the at least one solid oxide electrolyser cell, so that the oxygen rich gas exiting the oxygen rich gas output, which is hot from the operation of the at least one solid oxide electrolyser cell, is cooled prior to downstream distribution and so that the gas stream for the gas infeed (for example one or more of an air feed, a nitrogen stream feed or a steam stream) is heated prior to entry into the at least one solid oxide electrolyser cell.

In some embodiments the hydrogen output connects to at least one filter system of the air separation unit to filter entrained solids from a hydrogen stream output by the at least one solid oxide electrolyser cell from the hydrogen output of the at least one solid oxide electrolyser cell.

In some embodiments the hydrogen output connects to a cooled air stream of the air separation unit, for example either directly, or thermally via (across) a heat exchanger, the cooled air stream condensing or freezing steam particles entrained in the hydrogen stream so that they can be filtered out of the hydrogen stream by a filter (as water or ice can be entrapped by an appropriate filter), along with other filterable impurities. In some embodiments the filter is the at least one filter system of the air separation unit.

In some embodiments the nitrogen stream and the steam for the at least one solid oxide electrolyser cell are fed into the at least one solid oxide electrolyser cell at close to the operating temperature of the at least one solid oxide electrolyser cell.

In some embodiments the air separation unit further comprises at least one heat exchanger.

In some embodiments the air separation unit further comprises a cryogenic cooler.

In some embodiments the air separation unit further comprises at least two pressure columns, one at a relatively higher pressure than the other.

According to a sixth aspect of the present invention there is provided a method of operating an air separation system comprising an air separation unit (ASU) and at least one solid oxide electrolyser cell (SOEC or SOEL cell);
the air separation unit comprising a source gas infeed and a nitrogen output;
the at least one solid oxide electrolyser cell comprising an anode, a cathode and an electrolyte, a steam input and a hydrogen output;
wherein the nitrogen output thermally connects to the hydrogen output across a heat exchanger so that a nitrogen stream from the nitrogen output cools a hydrogen stream from the hydrogen output. In other words, the nitrogen output and the hydrogen output are in fluid flow communication with a heat exchanger for exchanging heat between a nitrogen stream from the nitrogen output and a hydrogen stream from the hydrogen output.

According to a seventh aspect of the present invention there is provided a method of operating an air separation system comprising an air separation unit (ASU) and at least one solid oxide electrolyser cell (SOEC or SOEL cell);
the air separation unit comprising a source gas infeed and a nitrogen output;
the at least one solid oxide electrolyser cell comprising an anode, a cathode and an electrolyte, a steam input and an oxygen rich gas output;
wherein the nitrogen output thermally connects to the oxygen rich gas output across a heat exchanger so that a nitrogen stream from the nitrogen output cools a oxygen rich gas stream from the oxygen rich gas output. In other words, the nitrogen output and the oxygen rich gas output are in fluid flow communication with a heat exchanger for exchanging heat between a nitrogen stream from the nitrogen output and an oxygen rich gas stream from the oxygen rich gas output.

According to an eighth aspect of the present invention there is provided a method of operating an air separation system comprising an air separation unit (ASU) and at least one solid oxide electrolyser cell (SOEC or SOEL cell);
the air separation unit comprising a source gas infeed and a nitrogen output;
the at least one solid oxide electrolyser cell comprising an anode, a cathode and an electrolyte, a steam input, a nitrogen rich gas input, an oxygen rich gas output and a hydrogen output;
wherein the nitrogen output connects to the nitrogen rich gas input, and a nitrogen stream from the nitrogen output to the nitrogen rich gas input thermally connects to either or both of a) an oxygen rich gas stream from the oxygen rich gas output and b) a hydrogen stream from the hydrogen output, in each case across one or more heat exchanger, so that the nitrogen stream is heated thereby before entering the nitrogen rich gas input of the at least one solid oxide electrolyser cell. In other words, a nitrogen stream from the nitrogen output to the nitrogen rich gas input and either or both of a) an oxygen rich gas stream from the oxygen rich gas output and b) a hydrogen stream from the hydrogen output are in fluid flow communication with at least one heat exchanger for exchanging heat between the nitrogen stream and either or both of a) the oxygen rich gas stream from the oxygen rich gas output and b) the hydrogen stream from the hydrogen output.

As with the air separation system of the first to fourth aspects of the present invention, by using the nitrogen stream from the ASU to feed into the SOEC, less ambient air is required to be drawn into the SOEC whereby there will be fewer additional components or impurities to that gas infeed—i.e. a more pure nitrogen supply, and less carbon dioxide and other contaminants. The system can even be a closed loop system if the oxygen rich gas stream is connected to the source gas infeed of the ASU, in accordance with the fifth aspect of the present invention.

The fifth aspect can be combined with any one or more of the sixth, the seventh or the eighth aspects. Likewise the sixth aspect can be combined with any one or more of the seventh or eighth aspects. Likewise the seventh aspect can be combined with the eighth aspect. Indeed any two or more of these four aspects of the present invention can be combined together.

In each case, the air separation unit may comprise additionally an air compressor that compresses a source gas after it has been fed into the source gas infeed, at least one additional heat exchanger, a cryogenic cooler and at least two pressure columns, one at a relatively higher pressure than the other.

To operate the SOEC, a current source is applied across the SOEC, which then electrolyses the steam to separate it into its components—hydrogen and oxygen.

In some embodiments, a nitrogen storage tank may be provided between the ASU and the SOEC to allow a buffer for the nitrogen stream from the ASU to the SOEC.

In some embodiments a hydrogen storage tank may be provided between the SOEC and the ASU to allow a buffer for the hydrogen stream from the SOEC to the ASU.

In some embodiments an oxygen or oxygen rich gas tank may be provided between the SOEC and the ASU to allow a buffer for the oxygen rich gas supply from the SOEC to the ASU.

Through the use of the at least one solid oxide electrolyser cell in combination with the air separation unit, for the purpose of oxygen and hydrogen production, the efficiency and purity of the produced gases can be increased. The ASU can produce more oxygen as there is a higher concentration of oxygen in the source gas—it having been oxygen enriched by the SOEC. Furthermore, the nitrogen from the ASU can be used to dry the hydrogen output from the SOEC and that hydrogen can also can be cleaned and dried by the ASU, whereby the SOEC can produce purer hydrogen. Yet further, impurities in the air-to-be-separated can be reduced as less fresh air is needed by the system, and the air through the SOEC can be replaced by nitrogen from the ASU whereby the amount of impurities circulating through the SOEC can also be reduced. These two pieces of equipment thus can operate together to increase efficiencies and purity of outputs.

According to a ninth aspect of the present invention there is provided an air separation system comprising a pressure swing adsorption system (PSA system) and at least one solid oxide electrolyser cell (SOEC or SOEL cell);
the pressure swing adsorption system comprising a source gas infeed;
the at least one solid oxide electrolyser cell comprising an anode, a cathode and an electrolyte, a steam input and an oxygen rich gas output, wherein the oxygen rich gas output connects to the source gas infeed of the pressure swing adsorption system. With this arrangement, the source gas (for example ambient air) can be enriched by oxygen rich gas exiting the oxygen rich gas output during operation of the at least one solid oxide electrolyser cell, or the oxygen rich gas can be the source gas.

The pressure swing adsorption system usually has a nitrogen output. A nitrogen stream will exit the nitrogen output during use of the pressure swing adsorption system.

In some embodiments the nitrogen output is connected to the at least one solid oxide electrolyser cell to feed the nitrogen stream from the pressure swing adsorption system to the at least one solid oxide electrolyser cell during use of the pressure swing adsorption system. The input gases to the at least one solid oxide electrolyser cell are therefore steam and nitrogen.

In some embodiments the oxygen rich gas (oxygen enriched nitrogen) exiting the at least one solid oxide electrolyser cell and the nitrogen stream exiting the nitrogen output of the pressure swing adsorption system both pass through a heat exchanger to cool the oxygen rich gas and to heat the nitrogen stream. This allows the oxygen rich gas exiting the oxygen rich gas output during operation of the at least one solid oxide electrolyser cell, which will be hot from the at least one solid oxide electrolyser cell, to be cooled and the nitrogen stream in-feeding into the at least one solid oxide electrolyser cell to be heated.

In some embodiments a hydrogen stream from the at least one solid oxide electrolyser cell can also (or instead) be cooled by the nitrogen stream (or an oxygen stream, or both) from the pressure swing adsorption system by a heat exchanger that thermally connects these two streams. In other words, the two streams are in fluid flow communication with a heat exchanger for exchanging heat between the two streams.

With this further aspect of the present invention, the efficiency and purity of the produced gases can be increased. The pressure swing adsorption system can produce more oxygen as there is a higher concentration of oxygen in the source gas—it having been oxygen enriched by the SOEC. Furthermore, impurities in the air-to-be-separated can be reduced as less fresh air is needed by the system. In particular, if the gas supplied through the SOEC in addition to steam is the nitrogen from the pressure swing adsorption system, there can be a closed cycle, whereby the amount of impurities circulating through the SOEC, and thus then ultimately through the pressure swing adsorption system, can also be reduced. Further, with the heat exchangers, the operating temperature differences can be utilised to help prepare gaseous input streams for the respective pieces of equipment, or for downstream storage. These two pieces of equipment thus can operate together to increase efficiencies and purity of outputs. In addition, hydrogen can be produced which is a valuable fuel of increasing importance for the reduction in the world's reliance on fossil fuels.

According to a tenth aspect of the present invention there is provided an air separation system comprising a pressure swing adsorption system (PSA system) and at least one solid oxide electrolyser cell (SOEC or SOEL cell);
the pressure swing adsorption system comprising a source gas infeed and a nitrogen output;
the at least one solid oxide electrolyser cell comprising an anode, a cathode and an electrolyte, a steam input and a hydrogen output;
wherein the nitrogen output thermally connects to the hydrogen output across a heat exchanger so that a nitrogen stream from the nitrogen output can cool a hydrogen stream from the hydrogen output. In other words, the nitrogen output and the hydrogen output are in fluid flow communication with a heat exchanger for exchanging heat between a nitrogen stream from the nitrogen output and a hydrogen steam from the hydrogen output.

According to an eleventh aspect of the present invention there is provided an air separation system comprising a pressure swing adsorption system (PSA system) and at least one solid oxide electrolyser cell (SOEC or SOEL cell);
the pressure swing adsorption system comprising a source gas infeed and a nitrogen output;
the at least one solid oxide electrolyser cell comprising an anode, a cathode and an electrolyte, a steam input and an oxygen rich gas output;
wherein the nitrogen output thermally connects to the oxygen rich gas output across a heat exchanger so that a nitrogen stream from the nitrogen output can cool a oxygen rich gas stream from the oxygen rich gas output. In other words, the nitrogen output and the oxygen rich gas output are in fluid flow communication with a heat exchanger for exchanging heat between a nitrogen stream from the nitrogen output and an oxygen rich gas steam from the oxygen rich gas output.

According to a twelfth aspect of the present invention there is provided an air separation system comprising a pressure swing adsorption system (PSA system) and at least one solid oxide electrolyser cell (SOEC or SOEL cell);
the pressure swing adsorption system comprising a source gas infeed and a nitrogen output;
the at least one solid oxide electrolyser cell comprising an anode, a cathode and an electrolyte, a steam input, a nitrogen rich gas input, an oxygen rich gas output and a hydrogen output;
wherein the nitrogen output connects to the nitrogen rich gas input, and a nitrogen stream from the nitrogen output to the nitrogen rich gas input thermally connects to either or both of a) a oxygen rich gas stream from the oxygen rich gas output and b) a hydrogen stream from the hydrogen output, in each case across one or more heat exchanger, so that the nitrogen stream can be heated thereby before entering the nitrogen rich gas input of the at least one solid oxide electrolyser cell. In other words, before connecting to the nitrogen rich gas input of the at least one solid oxide electrolyser cell, the nitrogen output and at least one of a) an oxygen rich gas stream from the oxygen rich gas output and b) a hydrogen stream from the hydrogen output are in fluid flow communication with at least one heat exchanger for exchanging heat between a nitrogen stream from the nitrogen output and the at least one of a) an oxygen rich gas stream from the oxygen rich gas output and b) a hydrogen stream from the hydrogen output.

By using the nitrogen stream from the PSA system, less ambient air is required to be drawn into the SOEC whereby there will be fewer additional components to that gas infeed—i.e. a more pure nitrogen supply, and less carbon dioxide and other contaminants. The system can even be a closed loop system if the oxygen rich gas stream is connected to the source gas infeed of the PSA system, in accordance with the ninth aspect of the present invention.

In some embodiments, a nitrogen storage tank may be provided between the PSA system and the SOEC to allow a buffer for the nitrogen stream from the PSA system to the SOEC.

In some embodiments a hydrogen gas tank may be provided between the SOEC and the nitrogen stream to allow a buffer for the hydrogen stream from the SOEC to the nitrogen stream.

In some embodiments an oxygen rich gas tank may be provided between the SOEC and the PSA system to allow a buffer for the oxygen rich gas supply from the SOEC to the PSA system.

The ninth aspect can be combined with any one or more of the tenth, the eleventh or the twelfth aspects. Likewise the tenth aspect can be combined with any one or more of the eleventh or twelfth aspects. Likewise the eleventh aspect can be combined with the twelfth aspect. Indeed any two or more of these four aspects of the present invention can be combined together.

According to a thirteenth aspect of the present invention there is also provided a method of operating an air separation system, the air separation system comprising a pressure swing adsorption (PSA) system and a solid oxide electrolyser cell (SOEC or SOEL cell);
the pressure swing adsorption system comprising a source gas infeed;
the at least one solid oxide electrolyser cell comprising an anode, a cathode and an electrolyte, a steam input and an oxygen rich gas output, wherein the oxygen rich gas output is connected to the source gas infeed of the pressure swing adsorption system.

In some embodiments the source gas (for example ambient air) is enriched compared to ambient air by oxygen rich gas from the oxygen rich gas output whereby a percentage of oxygen in a to-be-separated gas that passes through the air separation unit to the pressure columns is increased versus a percentage of oxygen in the source gas.

The pressure swing adsorption system usually has a nitrogen output. A nitrogen stream exits the nitrogen output during the process.

In some embodiments the nitrogen output is connected to the at least one solid oxide electrolyser cell to feed the nitrogen stream from the pressure swing adsorption system to the at least one solid oxide electrolyser cell during use of the pressure swing adsorption system. The input gases to the at least one solid oxide electrolyser cell are therefore steam and nitrogen. This also then allows a closed loop for the nitrogen/air through the air separation system, which provides the advantages already discussed above.

In some embodiments the oxygen rich gas (oxygen enriched nitrogen) exiting the at least one solid oxide electrolyser cell and the nitrogen stream exiting the nitrogen output of the pressure swing adsorption system both pass through a heat exchanger to cool the oxygen rich gas and to heat the nitrogen stream. This allows the oxygen rich gas exiting the oxygen rich gas output during operation of the at least one solid oxide electrolyser cell, which will be hot from the at least one solid oxide electrolyser cell, to be cooled and the nitrogen stream in-feeding into the at least one solid oxide electrolyser cell to be heated.

In some embodiments a hydrogen stream from the at least one solid oxide electrolyser cell can also (or instead) be cooled by the nitrogen stream (or an oxygen stream, or both) from the pressure swing adsorption system by a heat exchanger that thermally connects these two streams.

The PSA system may be a double stage PSA system, a rapid PSA system, a vacuum swing adsorption (VSA) system or a vacuum pressure swing adsorption (VPSA) system.

According to a fourteenth aspect of the present invention there is provided a method of operating an air separation system comprising a pressure swing adsorption system (PSA system) and at least one solid oxide electrolyser cell (SOEC or SOEL cell);
the pressure swing adsorption system comprising a source gas infeed and a nitrogen output;
the at least one solid oxide electrolyser cell comprising an anode, a cathode and an electrolyte, a steam input and a hydrogen output;
wherein the nitrogen output thermally connects to the hydrogen output across a heat exchanger so that a nitrogen stream from the nitrogen output cools a hydrogen stream from the hydrogen output. In other words, the nitrogen output and the hydrogen output are in fluid flow communication with a heat exchanger for exchanging heat between a nitrogen stream from the nitrogen output and a hydrogen stream from the hydrogen output.

According to an fifteenth aspect of the present invention there is provided a method of operating an air separation system comprising a pressure swing adsorption system (PSA system) and at least one solid oxide electrolyser cell (SOEC or SOEL cell);
the pressure swing adsorption system comprising a source gas infeed and a nitrogen output;
the at least one solid oxide electrolyser cell comprising an anode, a cathode and an electrolyte, a steam input and an oxygen rich gas output;
wherein the nitrogen output thermally connects to the oxygen rich gas output across a heat exchanger so that a nitrogen stream from the nitrogen output cools a oxygen rich gas stream from the oxygen rich gas output. In other words, the nitrogen output and the oxygen rich gas output are in fluid flow communication with a heat exchanger for exchanging heat between a nitrogen stream from the nitrogen output and an oxygen rich gas stream from the oxygen rich gas output.

According to a sixteenth aspect of the present invention there is provided a method of operating an air separation system comprising a pressure swing adsorption system (PSA system) and at least one solid oxide electrolyser cell (SOEC or SOEL cell);
the pressure swing adsorption system comprising a source gas infeed and a nitrogen output;
the at least one solid oxide electrolyser cell comprising an anode, a cathode and an electrolyte, a steam input, a nitrogen rich gas input, an oxygen rich gas output and a hydrogen output;
wherein the nitrogen output connects to the nitrogen rich gas input, and a nitrogen stream from the nitrogen output to the nitrogen rich gas input thermally connects to either or both of a) an oxygen rich gas stream from the oxygen rich gas output and b) a hydrogen stream from the hydrogen output, in each case across one or more heat exchanger, so that the nitrogen stream is heated thereby before entering the nitrogen rich gas input of the at least one solid oxide electrolyser cell. In other words, a nitrogen stream from the nitrogen output to the nitrogen rich gas input and either or both of a) an oxygen rich gas stream from the oxygen rich gas output and b) a hydrogen stream from the hydrogen output are in fluid flow communication with at least one heat exchanger for exchanging heat between the nitrogen stream and either or both of a) the oxygen rich gas stream from the oxygen rich gas output and b) the hydrogen stream from the hydrogen output.

By using the nitrogen stream from the PSA system, less ambient air is required to be drawn into the SOEC whereby there will be fewer additional components to that gas infeed—i.e. a more pure nitrogen supply, and less carbon dioxide and other contaminants. The system can even be a closed loop system if the oxygen rich gas stream is connected to the source gas infeed of the PSA system, in accordance with the fifteenth aspect of the present invention.

The thirteenth aspect can be combined with any one or more of the fourteenth, the fifteenth or the sixteenth aspects. Likewise the fourteenth aspect can be combined with any one or more of the fifteenth or sixteenth aspects. Likewise the fifteenth aspect can be combined with the sixteenth aspect. Indeed any two or more of these four aspects of the present invention can be combined together.

In each case, the pressure swing adsorption system may comprise additionally at least one pump for raising or lowering the pressure of the air to be separated, and at least one absorber.

To operate the SOEC, a current source is applied across the SOEC, which then electrolyses the steam to separate it into its components—hydrogen and oxygen.

In each aspect of the present invention, in some embodiments the at least one solid oxide electrolyser cell operates at a temperature of between 400 and 1000 degrees centigrade. More typically it operates at a temperature of between 450 and 650 degrees centigrade.

For each aspect of the present invention, in some embodiments the at least one solid oxide electrolyser cell is part of a stack of such cells, the outputs from the cells together connecting to the air separation unit or the pressure swing adsorption system.

In some embodiments the stack of solid oxide electrolyser cells may be connected to both the air separation unit and the pressure swing adsorption system, the air separation system thus comprising an air separation unit, a pressure swing adsorption system and at least one solid oxide electrolyser cell stack. Indeed, in some embodiments, all aspects of the present invention may be combined within an air separation plant.

In each method, the air separation system may be one of the air separation systems of a preceding or subsequent aspect of the invention, or combinations thereof.

### BRIEF DESCRIPTION OF THE DRAWINGS

These and other features of the present invention will now be described in further detail, purely by way of example, with reference to the accompanying drawings, in which:

FIG. 1 shows a schematic illustration of a prior art air separation unit (ASU);

FIG. 2 shows a first embodiment of the present invention in which at least one SOEC has been incorporated into the air infeed for the ASU of FIG. 1 to provide oxygen enriched air to the ASU;

FIG. 3 illustrates schematically the operation of a SOEC, as known from the prior art;

FIG. 4 shows the embodiment of FIG. 2, further modified to recycle nitrogen from the ASU.

FIG. 5 shows the embodiment of FIG. 4, further modified and to utilise the hydrogen output from the at least one SOEC in the ASU;

FIG. 6 shows further modified versions in which additional buffer tanks are shown;

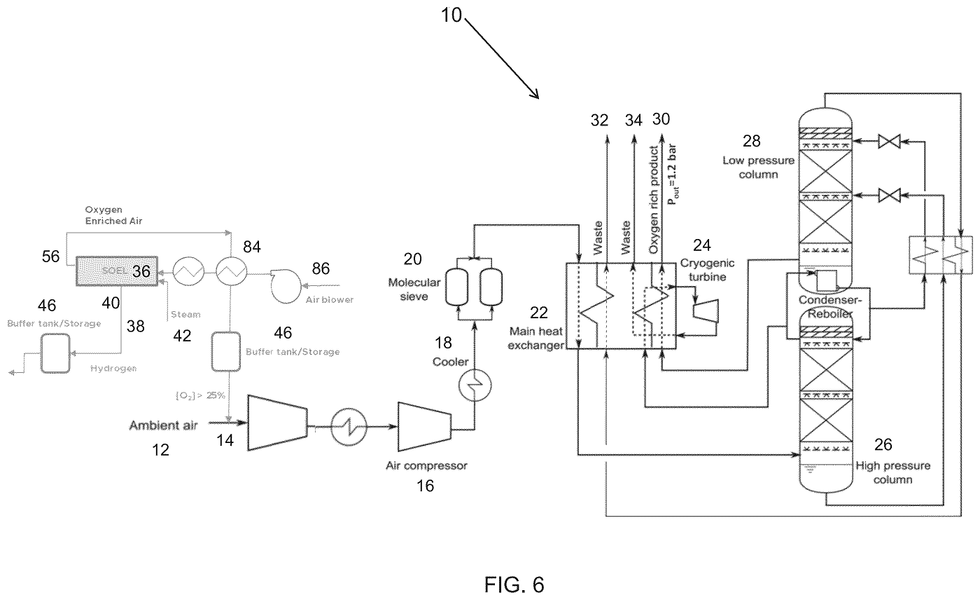

FIG. 7 shows further modified versions in which additional buffer tanks are shown;

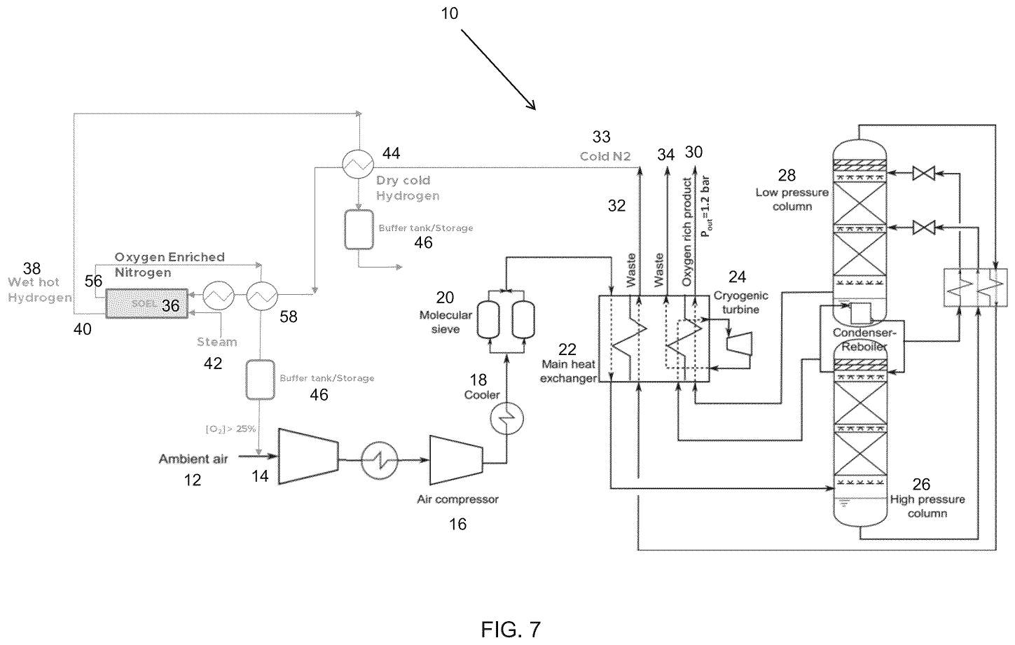

FIG. 8 shows a schematic illustration of a prior art vacuum pressure swing adsorption (VPSA) system;

FIG. 9 shows a further embodiment of the present invention in which at least one SOEC has been incorporated into the air infeed for the VPSA of FIG. 8 to provide oxygen enriched air to the ASU and to recycle nitrogen output from the VPSA through the at least one SOEC; and

FIG. 10 shows a modified version where an additional buffer tank is provided—for the hydrogen.

### DETAILED DESCRIPTION

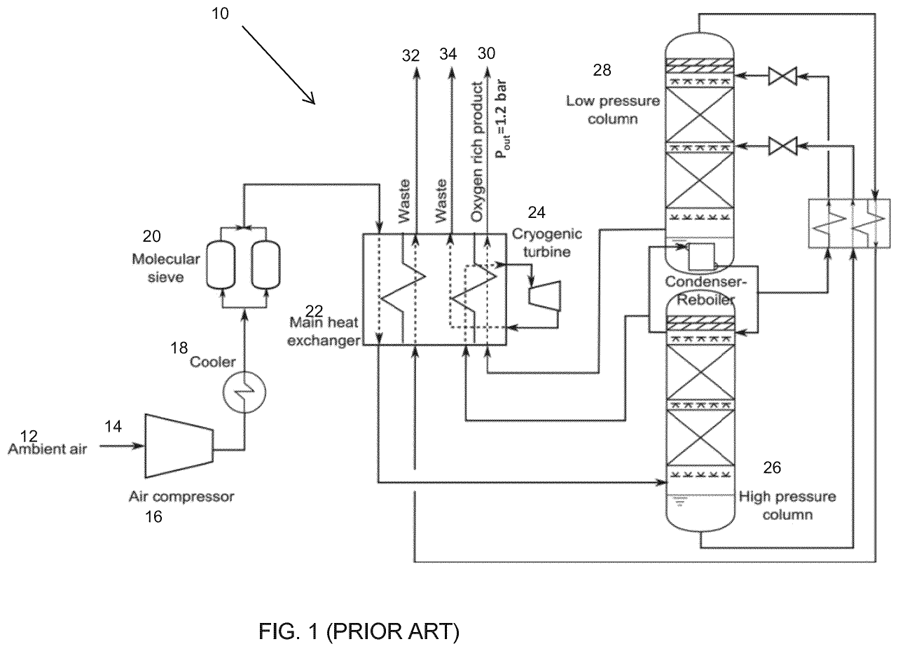

Referring first of all to FIG. 1, a prior art air separation unit (ASU) 10 is shown. It allows substantially pure gases to be separated from a source gas—here ambient air 12.

The ASU 10 comprises a source gas infeed 14, a compressor 16 for compressing the source gas 12, a cooler 18 for cooling the source gas 12 after its compression, and a filter system 20—here in the form of a molecular sieve—for filtering large particulates or other solids and contaminants out of the compressed air, such as dust and pollen, or carbonaceous deposits such as soot. The ASU 10 then additionally comprises a main heat exchanger 22 with a cryogenic engine 24 for performing cryogenic cooling onto that generally clean (filtered) source gas until it at least partially liquefies. That cryogenically cooled fluid is then passed to distilling columns—usually comprising at least two pressure columns—one at a relatively higher pressure than the other, and thus comprising a high pressure column 26 and a low pressure column 28. The distilling columns 26, 28 then selectively distil the fluid out into separate gaseous components at their various boiling temperatures using controlled changes in the temperature and pressure of the liquid, for example by allowing the fluid temperature to rise, or the pressure to drop.

Outputs from the distilling columns 26, 28 then feed back to the main heat exchanger 22, or otherwise vent from the ASU 10, as separated gaseous components such as oxygen, nitrogen, argon and others (or waste) via separate outputs. These include an oxygen output 30, a nitrogen output 32 and one or more waste or other output 34—this may also include a separate output for argon if the ASU's distillation columns are operated to separate and capture argon from the source gas.

The ASU process can produce high purity gases due to the significant differences in the boiling point of the respective components.

This cryogenic air separation process requires various heat exchangers, air compressors and separation/distilling columns, and the energy for refrigeration (cooling) and condensing/rebuilding the fluid in the separation/distilling columns. The process is energy-intensive due to the requirement to refrigerate the air to low temperatures (cryogenic temperatures), and to pressurise it to high pressures (to make the low temperature not as low as would otherwise be the case).

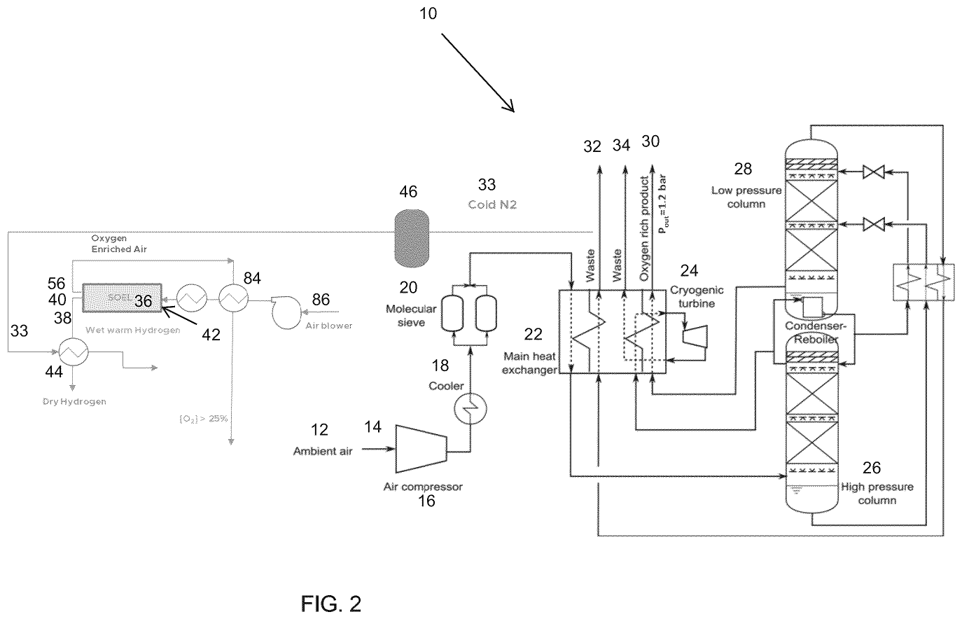

Referring next to FIG. 2, a first embodiment of the present invention is illustrated. In this embodiment, that prior art ASU 10 is connected to at least one solid oxide electrolyser cell 36. The at least one solid oxide electrolyser cell may be hereinafter referred to as an SOEL or SOEC, which terms can be used substantially interchangeably—solid oxide electrolyser versus solid oxide electrolyser cell. Such electrolysers or cells may be in the form of a stack of cells, or multiple stacks of cells, as commonly a singular cell has too low an output to be commercially useful, whereas a stack or multiple stacks can offer considerable commercial benefits. A single SOEL is shown for simplicity.

With the combination of an ASU with at least one SOEC, it becomes possible to make use of a nitrogen stream 33 exiting the nitrogen output 32 of the ASU 10. As shown, the at least one SOEC 36 operates to generate a hydrogen stream 38 through a hydrogen output 40, which hydrogen stream 38 is generated by splitting steam that enters the at least one SOEC 36 via a steam input 42 into its hydrogen and oxygen components. That hydrogen stream 38 will be very hot when exiting the at least one SOEC—usually at between 450 and 750 degrees centigrade. It will also be wet as the steam is only partially split into its separate components, whereby the superheated steam will partially entrain into that hydrogen stream 38.

As that hot and wet hydrogen is difficult to utilise in its vented form from the at least one SOEC 36, and since likewise the nitrogen stream 33 from the ASU is difficult to use in its vented form from the ASU 10—due to it still being very cold (it is still closer to its freezing point as it exits the main heat exchanger 22 than ambient air temperature), these two gas streams can be passed through a heat exchanger 44 to cool the wet hydrogen stream 38 and to heat the cold nitrogen stream 33.

To buffer the gas streams, buffer tanks 46 may be provided. This allows the production rates of the hydrogen and the nitrogen to be independent of each other, while still allowing such heat exchange operations to be carried out when desired or necessary.

The cooling of the wet hydrogen stream 38 has a surprising benefit too as the temperature of the nitrogen will typically be colder than the freezing point of water, whereby the flow through the heat exchanger 44 can freeze any water entrained in the hydrogen stream 38, which then allows the hydrogen to be dried thereby as the water is then easy to separate from the hydrogen—in that it simply condenses out of the hydrogen stream. The hydrogen stream 38 thus can be value-added as it can be more pure and dry.

In this embodiment there is also an air heating heat exchanger 84 for heating air before it is passed into the at least one SOEC, as it is beneficial to feed hot air rather than cold air into the at least one SOEC as it enables the at least one SOEC to maintain its required operating temperature. For this purpose, a hot oxygen enriched air stream exiting a hot gas (oxygen enriched) output 56 of the at least one SOFC is in fluid flow communication with the air heating heat exchanger 84 for exchanging heat between the hot oxygen enriched air stream and the air (in this embodiment fed by an air blower 86).

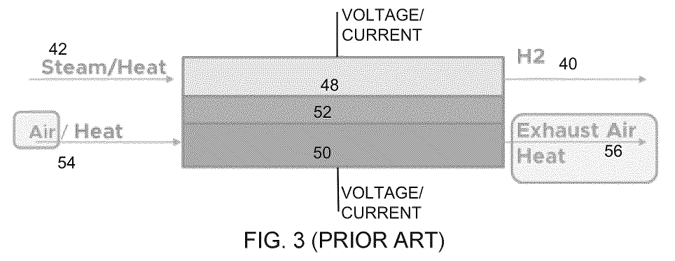

Referring next to FIG. 3, the operation of an SOEC is schematically illustrated. As shown, the SOEC 36 comprises an anode 48, a cathode 50, an electrolyte 52, the hydrogen output 40, the steam input 42, plus also a hot gas (usually nitrogen rich) input 54 and a hot gas (oxygen enriched) output 56. To operate the SOEC, a current source is applied across the SOEC, which then, through electrolysis, separates from the steam some of its components by splitting the water molecules, thus producing an output of hydrogen and oxygen, with the hydrogen venting through the hydrogen output 40 and the oxygen enriching the hot gas output at the hot gas output 56. For this to occur, the steam is fed into the cathode, which is porous. When the current and thus a voltage is applied, the steam at the cathode-electrolyte interface is reduced to form pure H2 and oxygen ions. The hydrogen gas then diffuses back up through the cathode and is collected at its surface as hydrogen fuel, while the oxygen ions are conducted through the dense electrolyte. The electrolyte must be dense enough that the steam and hydrogen gas cannot diffuse through and lead to the recombination of the H2 and O2—. At the electrolyte-anode interface, the oxygen ions are oxidized to form pure oxygen gas, which is collected at the surface of the anode.

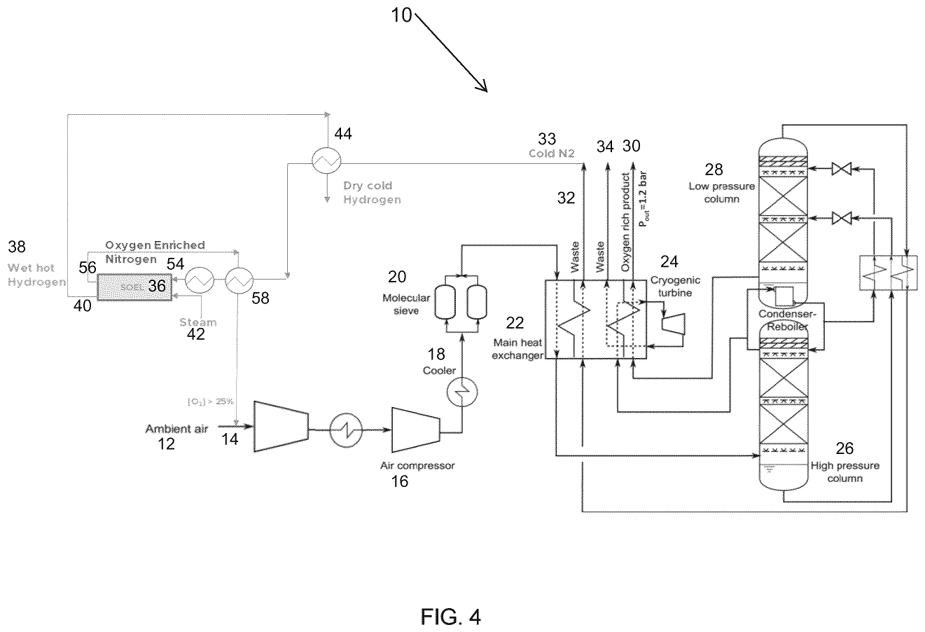

Referring next to FIG. 4, a second embodiment of the present invention is shown. In this embodiment, the oxygen enriched gas output 56 is connected to the source gas infeed 14 of the ASU 10. Additionally, the nitrogen stream 33 from the ASU 10 is still thermally connected to the hydrogen stream 38 from the at least one SOEC 36 via a heat exchanger 44, although it is now repositioned in this schematic illustration to be located between the ASU 10 and the SOEC 36, as the nitrogen stream 33 is also connected to the hot gas input 54 for the at least one SOEC 36. With this arrangement, oxygen enriched nitrogen venting from the hot gas output 56 of the at least one SOEC 36 can be fed into the source gas infeed 14 of the ASU to provide an oxygen enriched feed gas to the ASU. In this manner, whether the oxygen enriched nitrogen is combined with ambient air for the ASU 10 or is instead provided as the entirety of the source gas supply for the ASU 10, the source gas supplied to the main heat exchanger 22 of the ASU 10 will have a higher oxygen content than ambient air 12 as the at least one SOEC supplies oxygen enriched gas at a percentage higher than 21% due to the operation of the at least one SOEC separating oxygen out of the steam and using it to enrich the gas output from the anode side of the at least one SOEC 36. As a consequence, while processing the same volume of source gas, the ASU 10 will produce a larger volume of oxygen, thus increasing the efficiency of the production of oxygen by the ASU versus an arrangement that processes just ambient air.

Secondly, by using the nitrogen stream 33 to cool the hydrogen stream 38 from the cathode side of the at least one SOEC 36, the above described benefits can again be utilised.

Thirdly, by connecting that nitrogen stream also to the hot gas input 54 for the at least one SOEC 36, it becomes possible to avoid using ambient air 12 (or just ambient air) as the infeed gas for the at least one SOEC. Ambient air has oxygen and impurities in it such as dust and pollen, and carbonaceous materials such as soot, any or some of which can reduce the operational efficiency of the electrolysis process. Attempts can be made to filter the solids out, but there are still inefficiencies arising from the use of ambient air. Replacing or supplementing that ambient air with the substantially pure nitrogen stream 33 from the ASU 10 removes or reduces substantially all of the unnecessary or undesirable components of the infeed gas. Further, as it can be heated by the hydrogen from the at least one SOEC 36, it can be fed in at an appropriate temperature—typically hotter than the ambient air temperature.

Instead of or in addition to heating the nitrogen stream 33 with the hydrogen stream 38, the nitrogen stream 33 can be heated by passing the oxygen enriched gas from the hot gas output 56 of the at least one SOEC 36 across the nitrogen stream 33 again via a heat exchanger 58. This can help optimise the temperature of the nitrogen stream 33 for inputting into the at least one SOEC 36, while also cooling the oxygen enriched gas for feeding to the ASU, thus further enhancing the efficiency of the system as the oxygen enriched gas could be fed into the ASU at a temperature below that of the ambient air, it thus requiring less cooling after compression.

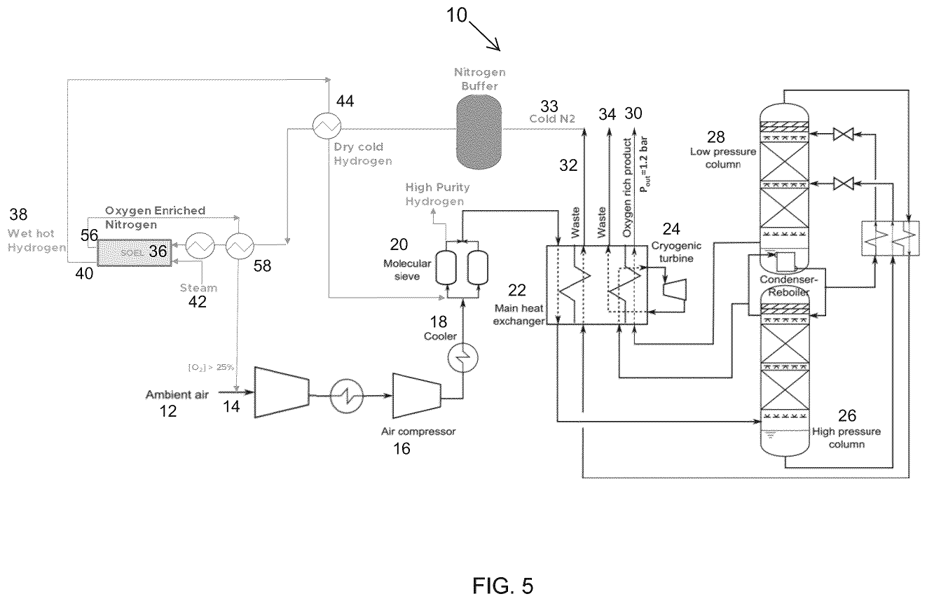

Referring next to FIG. 5, a further embodiment of the present invention is shown, in which the features of FIG. 4 are supplemented by additionally feeding the cooled hydrogen stream 38 into and through the filter system 20 of the ASU 10. This can then allow any water particulates (or other filterable components) in the hydrogen stream 33 (which may be at a temperature under zero degrees centigrade due to cooling by the nitrogen stream 33 in the respective heat exchanger 44 therebetween) to be filtered from the hydrogen stream, thus further improving the purity of the hydrogen stream. Additionally, given the low temperature of this stream it could help with the cooling of the compressed source gas in the ASU 10, or cool the cooler for that compressed source gas, or help to keep the filter system cool.

Integrating the at least one SOEC 36 with the ASU 36 thus provides multiple advantages:

Firstly, if the at least one SOEC 36 can produce enough oxygen enriched gas at its anode-side, hot gas output 56, and if the nitrogen from the ASU 10 can replace the at least one SOEC's air input, there is no need to use ambient air in the ASU cycle.

Secondly, if recycling the nitrogen stream through the at least one SOEC and back into the ASU in an oxygen enriched state, oxygen becomes the only product from the ASU (along with the separated nitrogen) since there will be no additional waste gas components being introduced into the cycle by introducing fresh ambient air. This means that the argon separation cycle need not be continued by the distillation vessels once the initial volume thereof is removed (i.e. from the start-up gas, if present therein).

Thirdly, as the gas fed to the ASU is oxygen enriched, it becomes possible to increase the percentage of oxygen in the supplied gas to the ASU 10. As a consequence, very high oxygen purity is possible as the output of the ASU 10, and at a lower processing cost as less source gas is being processed. This is also contributed to because there is less in-feed impurity (H₂O, CO₂, hydrocarbons, dust, pollen, carbonaceous particulates, etc. . . . )

Additionally, there will be less sweep flow required (heat input) at the inputs into the at least one SOEC as the inflowing gas (and potentially also the steam) can be heated by the outflowing hydrogen or oxygen enriched gas from the at least one SOEC.

Further, as the flow from the at least one SOEC will be at pressure due to its elevated temperature, there will be lower energy requirements for compression of the source gas into the ASU 10.

As already mentioned, with a closed loop for the source gas, there will be no requirement for ongoing argon separation. Indeed, if the initial amount is treated as a waste gas, no argon separation unit is even required.

The combination of the two technologies also enable higher oxygen and Hydrogen purity in the outputs, while still using the ASU distillation process, as the gas to be separated is now effectively a synthetic air, making the molecular sieve adsorption more straightforward—there are fewer impurities in it, and dust and pollen, along with hydrocarbons and carbonaceous impurities such as soot are effectively all eliminated. Further, if no water (moisture) is entrained in the source gas (the oxygen enriched nitrogen can be cooled by the nitrogen stream to remove it), there is no need for water to be condensed and removed therefrom.

Further advantages include the benefit that there can be a lower overall ASU and SOEC/SOEL capital expense when setting up the plant for a given oxygen volume output as the production efficiency is higher, thus enabling smaller equipment to achieve the same outputs. This is in addition to the improved operation efficiencies and energy usage. Further, due to the reduced number of components in the source gas, and the reduced contaminants, there will be less corrosion in the ASU 10 and less electrode degradation in the at least one SOEC 36.

Yet further, use of the cold streams (nitrogen stream in particular, but potentially also the other streams from the main heat exchanger 22 or the ASU 10, such as the oxygen stream or the waste stream) to cool and thus dry (and thus purify further) the hydrogen stream 38, and potentially also one of the possibly redundant molecular sieves to further dry and filter the last water or other impurities from the hydrogen, enable a more pure hydrogen to be sources from the at least one SOEC.

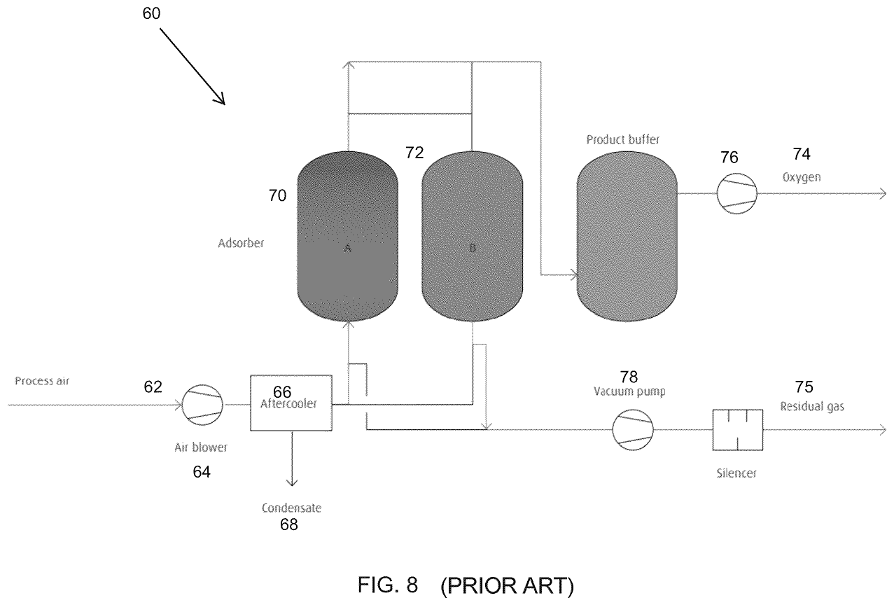

Referring next to FIG. 8, a prior art pressure swing adsorption (PSA) system is schematically shown. This alternative technique for separating gas species from a mixture of gases (typically air) achieves the separation again by controlling pressure (and temperature), but rather than using cryogenics and the respective freezing/evaporation points of the different components or species of the gas mixture, the molecular characteristics and affinity for an adsorbent material are used as these allow the separations to be controlled. Often PSA systems operate at or near ambient temperatures.

The PSA system 60 comprises a source gas infeed 62, an air blower or air pump 64 to blow or suck the source gas into the PSA system and to compress it above atmospheric pressure, an aftercooler 66 to cool the pressurised gas and to extract any condensate 68 thereby formed, and at least one adsorber-containing tank 70, 72. From the adsorber-containing tanks 70, 72, outlets 74, 75 for the separated gas components are provided, including, for separated air, an oxygen outlet 74 and a residual gas outlet 75. Depending upon the number of gases being separated, more specific outlets can also be provided. One residual gas may be nitrogen.

In the adsorber-containing tanks, adsorbent materials such as zeolites (aka molecular sieves) and activated carbon can be used as the trapping material. They preferentially adsorb a target gas species—for example at high pressure. The process then drops the pressure within the tank to desorb the adsorbed gas, whereby specific gases can be captured and selectively released. To drop the pressure, venting pumps 76, 78 (or vacuum pumps) might be used—e.g. connected to each outlet 74, 75, 80—to suck the separated gases from the tanks.

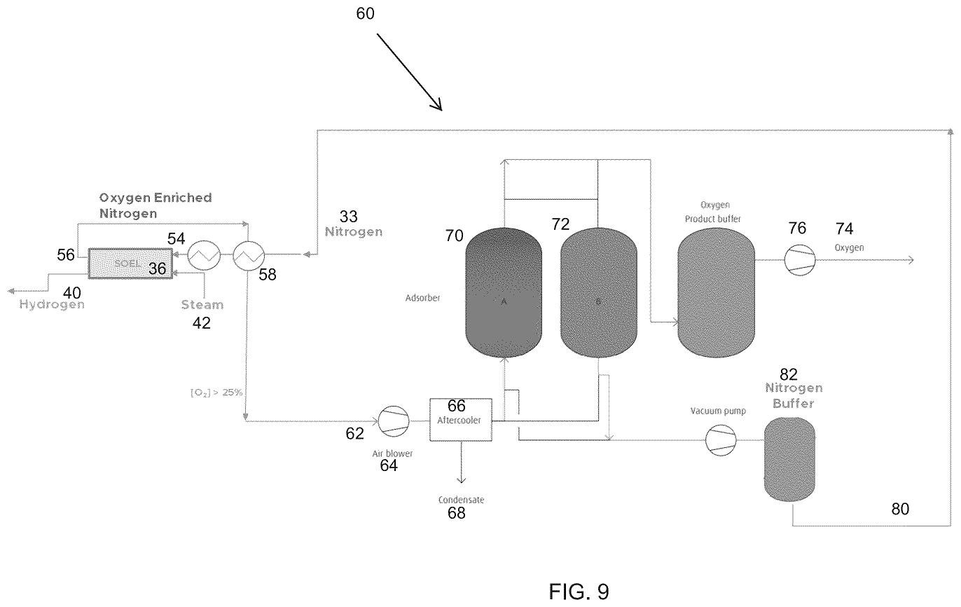

Referring next to FIG. 9, the PSA system 60 is now shown to be combined with at least one SOEC in accordance with the present invention. The at least one SOEC is essentially the same as that from the previous embodiments of FIGS. 1 to 5, with an anode 48, a cathode 50, and an electrolyte 52, a steam input 42, and a hot gas input 54, plus also a hydrogen output 40 and a hot gas (oxygen enriched) output 56. However, rather than the at least one SOEC 36 being connected to an ASU 10, it is connected to the PSA system 60. As with the previous embodiments, it may be one SOEL, one SOEC, a stack of SOECs, multiple stacks or multiple SOELs. A single SOEL is shown for simplicity.

In this respect, the hot gas output 56 connects to the source gas infeed 62 of the PSU system and the nitrogen outlet 80 of the PSA system 60 connects to the hot gas input 54 of the at least one SOEC 36.

The nitrogen stream from the nitrogen outlet 80 passes across the oxygen enriched gas stream from the hot gas output 56 from the anode side of the at least one SOEC 36 across a heat exchanger 58, much like in the embodiment of FIG. 5, and for a similar purpose—to allow the nitrogen stream to be preheated by the oxygen enriched gas—which will be hot as it exits the at least one SOEC 36. This also cools the oxygen enriched gas ready for supply to the PSA system's source gas infeed 62.

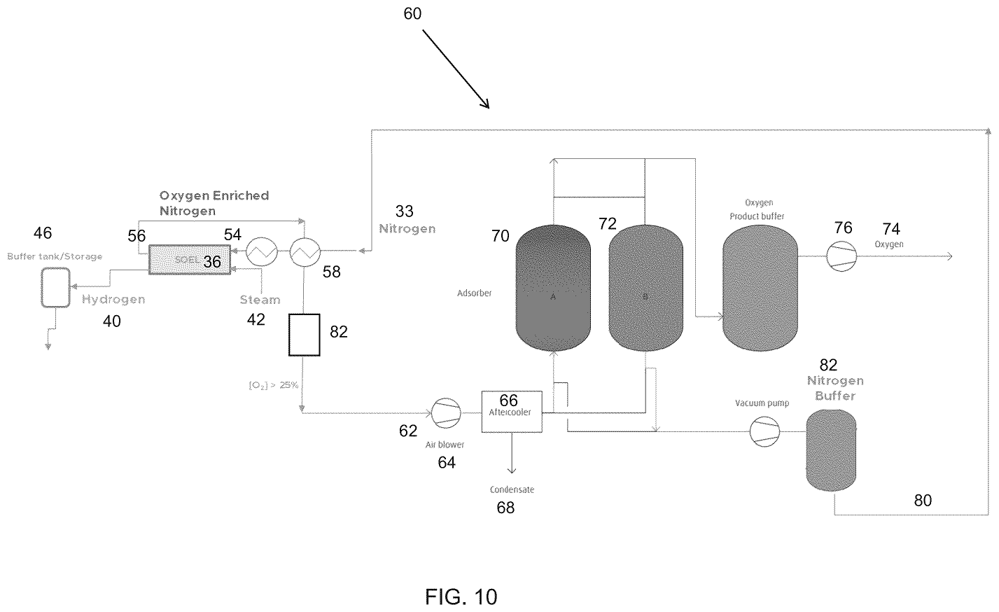

Buffer tanks 82 may be provided for the nitrogen stream (as shown in FIG. 9) or the oxygen enriched gas (see FIG. 10) to allow for a more continuous or steady supply pressure, as also for the earlier embodiments.

In a further embodiment, the hydrogen exiting the at least one SOEC 36 can also pass across the nitrogen stream via a heat exchanger, much like that shown in FIG. 5. Again this will offer similar advantages as the connection therebetween in the embodiment of FIG. 5.

A buffer tank 46 might be provided for the hydrogen—see, for example, FIG. 10.

By incorporating the at least one SOEC with the PSA system 36, multiple advantages are again realised. For example, there is no need for a continuous supply of ambient air as the at least one SOEC and PSA system can operate with a closed loop, much like the embodiment of FIG. 5, assuming that the gas outputs from the at least one SOEC and the PSA system are adequately balanced (as likewise with the ASU embodiments), when running (or with suitable buffer tanks). This thus then means that there is a clean, dry nitrogen closed loop running between the at least one SOEC and the PSA system.

Also, as with the previous embodiments, this invention can be retrofitted to existing plant or optimally designed for new plants.

With the use of the at least one SOEC, the PSA system becomes competitive versus ASU technology. In particular, by using the oxygen enriched supply from the at least one SOEC, the oxygen production capacity of the PSA system is substantially increased, as oxygen is only product—argon and other air components no longer need to be separated. Further, due to the absence of argon and other impurities in the air to be separated—while using a closed loop cycle from the PSA system to the at least one SOEC and back to the PSA system, a higher oxygen purity (potentially >99%) is possible as some impurities can have similar affinities to adsorbtion as oxygen, and they will become absent from the cycle. In particular, with the closed loop, there will be less or no H₂O, CO₂, hydrocarbons and carbonaceous impurities, etc.

There will also be less sweep flow required (heat input) at the at least one SOEC's inputs as the recycled nitrogen feed can be preheated by the enhanced oxygen flow and potentially also the hydrogen stream.

There will also be less corrosion in the PSA system as the cycling nitrogen will have less contaminants in it, and there will be less electrode degradation in the at least one SOEC again due to the reduction in contaminants.

Furthermore, as the gas in the system will be compressed throughout the loop and cycles, there will be a lower energy requirement for compression of the infeed gas, as there will be less or no ambient air being fed into the cycle.

Yet further, as the gas recycles through the system, more of the oxygen can be extracted, and there will be less moisture in the nitrogen loop, so there will be less or no water to be condensed and removed therefrom.

Various embodiments of the present invention have been described above purely by way of example. Modifications in detail may be made to the invention within the scope of the claims as appended hereto.

1. An air separation system comprising an air separation unit and at least one solid oxide electrolyser cell;
the air separation unit comprising a source gas infeed;
the at least one solid oxide electrolyser cell comprising an anode, a cathode and an electrolyte, a steam input and an oxygen rich gas output, wherein the oxygen rich gas output connects to the source gas infeed of the air separation unit.

2. An air separation system according to claim 1, wherein;
the air separation unit further comprises a nitrogen output;
the at least one solid oxide electrolyser cell further comprises a hydrogen output;
wherein the nitrogen output and the hydrogen output are in fluid flow communication with a heat exchanger for exchanging heat between a nitrogen stream from the nitrogen output and a hydrogen stream from the hydrogen output, so that the nitrogen stream from the nitrogen output can cool the hydrogen stream from the hydrogen output.

3. An air separation system according to claim 1, wherein;
the air separation unit further comprises a nitrogen output;
wherein the nitrogen output and the oxygen rich gas output are in fluid flow communication with a heat exchanger for exchanging heat between a nitrogen stream from the nitrogen output and an oxygen rich gas steam from the oxygen rich gas output, so that the nitrogen stream from the nitrogen output can cool the oxygen rich gas stream from the oxygen rich gas output.

4. (canceled)

5. The air separation system of claim 1, wherein a nitrogen output from the air separation unit is connected to the at least one solid oxide electrolyser cell to feed a nitrogen stream from the air separation unit to the at least one solid oxide electrolyser cell during use of the air separation unit.

6. The air separation system of claim 5, wherein a buffer tank is provided for the nitrogen stream.

7. (canceled)

8. The air separation system of claim 1, wherein the oxygen rich gas output and a gas infeed for the at least one solid oxide electrolyser cell are in fluid flow communication with a heat exchanger for exchanging heat between the oxygen rich gas output and the gas infeed.

9. The air separation system of claim 1, wherein a hydrogen output from the at least one solid oxide electrolyser cell is connected to the air separation unit.

10-13. (canceled)

14. A method of operating an air separation system, the air separation system comprising an air separation unit and a solid oxide electrolyser cell;
the air separation unit comprising a source gas infeed;
the at least one solid oxide electrolyser cell comprising an anode, a cathode and an electrolyte, a steam input and an oxygen rich gas output, wherein the oxygen rich gas output is connected to the source gas infeed of the air separation unit.

15. A method of operating an air separation system according to claim 14, wherein;
the air separation unit further comprises a nitrogen output;
the at least one solid oxide electrolyser cell further comprises a hydrogen output;
wherein the nitrogen output and the hydrogen output are in fluid flow communication with a heat exchanger for exchanging heat between a nitrogen stream from the nitrogen output and a hydrogen stream from the hydrogen output so that the nitrogen stream from the nitrogen output cools the hydrogen stream from the hydrogen output.

16. A method of operating an air separation system according to claim 14, wherein;
the air separation unit further comprises a nitrogen output;
wherein the nitrogen output and the oxygen rich gas output are in fluid flow communication with a heat exchanger for exchanging heat between a nitrogen stream from the nitrogen output and an oxygen rich gas stream from the oxygen rich gas output so that the nitrogen stream from the nitrogen output cools the oxygen rich gas stream from the oxygen rich gas output.

17. (canceled)

18. The method of claim 14, wherein source gas is oxygen enriched compared to ambient air by oxygen rich gas from the oxygen rich gas output.

19. The method of claim 14, wherein source gas is oxygen rich gas from the at least one solid oxide electrolyser cell.

20. The method of claim 14, wherein a nitrogen output from the air separation unit is connected to the at least one solid oxide electrolyser cell to feed a nitrogen stream from the nitrogen output to the at least one solid oxide electrolyser cell.

21. The method of claim 20, wherein a buffer tank is provided for the nitrogen stream.

22. The method of claim 21, wherein nitrogen stored in the buffer tank is used for system start-up.

23. The method of claim 14, wherein a hydrogen stream exiting the at least one solid oxide electrolyser cell and a nitrogen stream exiting a nitrogen output of the air separation unit both pass through a heat exchanger to cool the hydrogen stream and to heat the nitrogen stream.

24. The method of claim 14, wherein the oxygen rich gas output and a gas infeed for the at least one solid oxide electrolyser cell are in fluid flow communication with a heat exchanger for exchanging heat between the oxygen rich gas output and the gas infeed so that the oxygen rich gas exiting the oxygen rich gas output, which is hot from the operation of the at least one solid oxide electrolyser cell, is cooled and so that the gas infeed is heated.

25-26. (canceled)

27. The method of claim 14, wherein the air separation system is in accordance with claim 1.

28-47. (canceled)

48. An air separation plant comprising one or more air separation system according to claim 1.

49. The air separation plant of claim 48, wherein there are multiple solid oxide electrolyser cells and they are part of one or more stack of such cells, the outputs from the cells together connecting to the air separation unit.
